(19) United States
(12) Patent Application Publication
(10) Pub. No.: US 2026/0003151 A1
(43) Pub. Date: Jan. 1, 2026

(54) QUICK-RELEASE PULLING GRIP FOR INSTALLING FIBER OPTIC CABLES AND METHODS OF USING SAME

(71) Applicant: CORNING RESEARCH & DEVELOPMENT CORPORATION, Corning, NY (US)

(72) Inventors: Brandon Duvall Compton, Newton, NC (US); Cameron Blake Crisp, Newton, NC (US); Brandon O’Brien Norwood, Lincolnton, NC (US)

(21) Appl. No.: 19/244,242

(22) Filed: Jun. 20, 2025

Related U.S. Application Data
(60) Provisional application No. 63/665,353, filed on Jun. 28, 2024.

(51) Int. Cl. G02B 6/46

(52) U.S. Cl. CPC G02B 6/475

(57) ABSTRACT

A fiber optic cable assembly includes a fiber optic cable carrying a strength member and a plurality of optical fibers terminated by one or more fiber optic connectors. The cable assembly further includes a pulling grip assembly having a flexible line with a gripping end and an attachment end, a coupler at the attachment end, and a quick release assembly at the gripping end. The quick release assembly receives the coupler to releasably connect the attachment end to the gripping end. The flexible line is routed through a pulling loop with the attachment end and the gripping end of the flexible line connected at an end of the fiber optic cable. The attachment end and the gripping end are releasable from each other at the end of the cable. A method of attaching a pulling grip assembly to a fiber optic cable is also disclosed.

### PRIORITY APPLICATION

This application claims the benefit of priority of U.S. Provisional Application No. 63/665,353, filed on Jun. 28, 2024, the content of which is relied upon and incorporated herein by reference in its entirety.

### TECHNICAL FIELD

This disclosure relates generally to fiber optic cables, and more particularly to a quick-release pulling grip for use during installation of fiber optic cables.

### BACKGROUND

The large amount of data and other information transmitted over the internet has led businesses and other organizations to develop large scale data centers for organizing, processing, storing, and/or disseminating large amounts of data. Data centers contain a wide range of information technology (IT) equipment including, for example, servers, networking switches, routers, storage subsystems, etc. Data centers further include a large amount of cabling and racks to organize and interconnect the IT equipment in the data center. Modern data centers may include multi-building campuses having, for example, one primary or main building and a number of auxiliary buildings in close proximity to the main building. All the buildings on the campus are interconnected by a local fiber optic network. Cables may be routed through conduits, ducts, raceways, etc. (“pathways”) within and between the buildings.

To route the fiber optic cables through these pathways during installation or upgrades, for example, one end of the cable is typically equipped with a pull grip assembly (referred to as a “pull grip” or “pulling grip”). A tension member, which extends through the pathway, is then coupled to the pulling grip, allowing the fiber optic cable to be pulled through the pathway, referred to herein as a cable pulling operation. Depending on factors such as the size of the fiber optic cable, the length of the pathway, and the resistance encountered during a cable pulling operation, the cable and its subunits may be subjected to high tensile forces, potentially reaching several hundreds of pounds.

A pulling grip must be removed after a cable pulling operation to expose multiple fiber optic cables or subunits (“legs”) of a single cable for connection to respective equipment. Typically, an operator is positioned on the ground near the equipment where the fiber optic cables will be connected after the cable has been pulled into place. This ground location is often referred to as the deployed location. Once the cable is pulled into place, the operator must remove the cable grip to expose the fiber optic cables for connection. This often requires the operator to move from the deployed location to the pathway through which the cable is being pulled. This pathway is often elevated and requires the use of a ladder or other lift equipment to access. In addition to cutting and removing different components of the pulling grip (e.g., cable ties, heat shrinks, knots, tape, etc.), the operator may need to relocate to several points along the pathway to access different parts of the pulling grip. Once the pulling grip is removed, the operator must return to the deployed location to connect the fiber optic cables to the equipment.

While current implementations of pulling grips for fiber optic cables and their use in routing fiber optic cables through pathways are generally satisfactory for their intended purpose, increased demand for bandwidth has led manufacturers and installers to identify several drawbacks to existing arrangements. For example, existing pulling grips require multiple steps and operator movements for removal, which are time-consuming and inefficient.

Therefore, there is a desire to provide pulling grips that can be removed from the cable without multiple removal steps or operator movements. Specifically, there is a desire to provide pulling grips that can be removed by an operator from the deployed location. This will enable more efficient installation of fiber optic cables to meet or exceed current installation demands.

### SUMMARY

According to one aspect of the disclosure, a fiber optic cable assembly is provided. The fiber optic cable assembly includes a fiber optic cable with a distribution end and an outer jacket that defines a cable interior that includes at least one strength member and a plurality of subunits each with at least one optical fiber terminated by a fiber optic connector at the distribution end of the fiber optic cable. The outer jacket includes an end through which each of the plurality of subunits extends to the fiber optic connector. A pulling loop is provided spaced from or extending beyond the end of the outer jacket, wherein the pulling loop is coupled to or defined by a portion of the at least one strength member. The fiber optic cable assembly further includes a pulling grip assembly that includes a flexible line that extends a length from a gripping end to an opposite attachment end, a coupler at the attachment end of the flexible line, and a quick release assembly at the gripping end of the flexible line. The quick release assembly is configured to receive the coupler to releasably connect the attachment end of the flexible line to the gripping end of the flexible line. The flexible line is routed through the pulling loop with the attachment end and the gripping end of the flexible line connected together at the distribution end of the fiber optic cable such that a tensile load imposed on the pulling grip assembly is transferred through the pulling loop to the strength member of the fiber optic cable along a load path that bypasses the fiber optic connector of each of the plurality of subunits.

In one embodiment, the quick release assembly may include a cap secured to the gripping end of the flexible line and a locking tube that extends a length between a first end, an opposite second end, and a hollow interior. The locking tube may be slidably arranged on the flexible line and slideable along the flexible line between a connected position in which the locking tube is selectively coupled to the cap and a released position in which the locking tube is decoupled from the cap. The quick release assembly may further include a locking member tethered to the gripping end of the flexible line at a location therealong between the locking tube and the cap. The coupler at the attachment end of the flexible line and the locking member may be configured to be releasably connected within the interior of the locking tube when the locking tube is in the connected position to transfer the tensile load imposed on the pulling grip to the fiber optic cable. The coupler and the locking member may be configured to decouple when the locking tube is moved to the released position.

In another embodiment, the coupler at the attachment end of the flexible line may be received in the locking tube from the first end and releasably connected to the locking member which may be received in the locking tube from the second end when the locking tube is in the connected position. The coupler and the locking member may be removed from the interior of the locking tube when the locking tube is in the released position. In yet another embodiment, the locking member may be a pin that includes a length. The length of the pin may be greater than an inner diameter of the locking tube.

In one embodiment, the cap may include a socket and an opening to the socket at a base of the cap. The socket may be configured to receive the second end of the locking tube to selectively couple the locking tube to the cap. Further, the second end of the locking tube may include a pair of external projections arranged opposite each other about a circumference of the locking tube. The pair of external projections may be configured to engage the cap to selectively couple the locking tube to the cap. In another embodiment, the cap may include a pair of bayonet slots arranged opposite each other about a circumference of the cap. Each of the pair of bayonet slots may be configured to receive one of the pair of external projections to selectively couple the locking tube to the cap. Additionally, each of the pair of bayonet slots may include a catch, and the cap may include a spring disposed in the socket. The spring may be configured to bias each of the pair of external projections into the catch of a respective one of the bayonet slots to maintain the connected position of the locking tube. In one embodiment, the pair of external projections may be part of the same pin that extends through the locking tube.

In yet another embodiment, the locking tube may include a ramp arranged within the interior of the locking tube proximate to the second end of the locking tube. The ramp may gradually increase in height along a length of the ramp from a first end to an apex at the pin.

In one embodiment, the quick release assembly may include a stopper attached to the gripping end of the flexible line and spaced a distance from the cap. The locking tube may be held captive between the stopper and the cap. In another embodiment, the pulling loop may include an eyelet through which the flexible line is routed. In yet another embodiment, the gripping end of the flexible cable may include a handle for pulling the fiber optic cable assembly. In one embodiment, the pulling grip assembly may include a sleeve attached at one end to the locking tube. The sleeve may be configured to cover the plurality of subunits.

According to another aspect of the disclosure, a method of attaching a pulling grip assembly to a fiber optic cable to form a fiber optic cable assembly is disclosed. The fiber optic cable includes a distribution end and an outer jacket that defines a cable interior that includes at least one strength member and a plurality of subunits each with at least one optical fiber terminated by a fiber optic connector at the distribution end of the fiber optic cable. The outer jacket includes an end through which each of the plurality of subunits extends to the fiber optic connector. The method includes providing a pulling loop spaced from or extending beyond the end of the outer jacket and providing the pulling grip assembly, wherein the pulling loop is coupled to or defined by a portion of the at least one strength member. The pulling grip assembly includes a flexible line that extends a length from a gripping end to an opposite attachment end, a coupler at the attachment end of the flexible line, and a quick release assembly at the gripping end of the flexible line. The method further includes routing the flexible line through the pulling loop, arranging the gripping end and the attachment end of the flexible line at the distribution end of the fiber optic cable, and connecting the quick release assembly to the coupler to releasably connect the attachment end of the flexible line to the gripping end of the flexible line.

In one embodiment, the quick release assembly may include a cap secured to the gripping end of the flexible line and a locking tube that includes a length between a first end, an opposite second end, and a hollow interior. The locking tube may be slidably arranged on the flexible line. The quick release assembly may further include a locking member tethered to the gripping end of the flexible line at a location therealong between the locking tube and the cap. The method may further include sliding the locking tube along the flexible line and coupling the locking tube with the cap to place the locking tube in a connected position. In yet another embodiment, the method may further include receiving the coupler and the locking member into the interior of the locking tube such that the attachment end of the flexible line is received into the locking tube from the first end and the locking member is received in the locking tube from the second end when the locking tube is in the connected position.

In another embodiment, the cap may include a socket and a pair of bayonet slots arranged opposite each other about a circumference of the cap. Each bayonet slot may include a catch, and the locking tube may include a pair of external projections arranged opposite each other about a circumference of the locking tube. The method may further include aligning the pair of external projections with the pair of bayonet slots, inserting the second end of the locking tube into the socket, and twisting the locking tube to position each of the pair of external projections with the catch of a respective one of the pair of bayonet slots to place the locking tube in the connected position. In yet another embodiment, the cap may include a spring disposed in the socket. The method may include releasing the locking tube such that the spring biases the pair of external projections into the catch of each of the pair of bayonet slots.

In another aspect of the disclosure, a method of routing a fiber optic cable assembly through a pathway is disclosed. The method includes attaching a pulling grip assembly to the fiber optic cable according to any of the previous embodiments and applying a tensile load on the flexible line of the pulling grip assembly to route the fiber optic cable assembly though the pathway. The pulling grip assembly directs the tensile load to the at least one strength member of the fiber optic cable along a load path that bypasses the fiber optic connector of each of the plurality of subunits.

According to one embodiment, the method may further include decoupling the locking tube from the cap, sliding the locking tube along the flexible line away from the cap, disconnecting the locking member of the quick release assembly from the coupler to decouple the attachment end of the flexible line from the gripping end of the flexible line, and pulling the gripping end of the flexible line to remove the pulling grip assembly from the fiber optic cable. In another embodiment, the method may include twisting the locking tube to remove each of the pair of external projections from the catch of a respective one of the pair of bayonet slots and pulling the locking tube out from the socket of the cap. In yet another embodiment, the cap may include a spring disposed in the socket. The method may further include pressing the locking tube further into the socket, twisting the locking tube, and releasing the locking tube such that the spring biases the locking tube out from the socket of the cap.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic illustration of a data center campus according to an embodiment of the disclosure.

FIG. 2 is a partial perspective view of an embodiment of a data hall of the data center of FIG. 1.

FIG. 3 is a schematic view of an embodiment of a row of equipment racks of the data hall of FIG. 2

FIG. 4 is a cross-sectional view of a fiber optic cable including a strength member according to an embodiment of the disclosure.

FIG. 5 is a perspective view of a fiber optic cable assembly including the fiber optic cable of FIG. 4, illustrating exposed lengths and connectors of exemplary subunits at a distribution end of the fiber optic cable.

FIG. 6 is a perspective view of the distribution end of the fiber optic cable of FIG. 5, illustrating a pulling grip assembly routed through a pulling loop of the fiber optic cable according to an embodiment of the disclosure.

FIG. 7 is a perspective view of the pulling loop of the fiber optic cable of FIGS. 5 and 6.

FIG. 8 is a perspective view of the pulling grip assembly of FIG. 6, illustrating additional details of a quick release assembly of the pulling grip assembly.

FIG. 9 is a schematic cross-sectional view of a locking tube of the quick release assembly of FIG. 8.

FIG. 10 is a schematic disassembled view of a cap of the quick release assembly of FIG. 8.

FIG. 11 is a schematic cross-sectional view of the quick release assembly of FIG. 8, illustrating the locking tube releasably coupled to the cap.

FIG. 12A is a cross-sectional view of the quick release assembly of the pulling grip assembly, illustrating the locking tube in the connected position to the cap for pulling a fiber optic cable through a pathway.

FIG. 12B is a view similar to FIG. 12A, illustrating the locking tube in the released position to remove the pulling grip assembly from the fiber optic cable.

FIG. 13 is a perspective view of a fiber optic cable assembly including a pulling grip assembly with a sleeve according to one embodiment of the disclosure.

### DETAILED DESCRIPTION

Various embodiments will be further clarified by examples in the description below. In general, the description relates to a quick-release pulling grip assembly for a fiber optic cable. The pulling grip assembly may be a single-use device configured to be easily removed from the fiber optic cable after a cable pulling operation. In that regard, the pulling grip assembly is capable of withstanding tensile loads imposed from a typical cable pulling operation, transferring the tensile loads through a furcation of the fiber optic cable to one or more internal strength members of the fiber optic cable. After the cable pulling operation, the pulling grip assembly may be quickly and easily removed from the fiber optic cable in a tool-less manner. In particular, the pulling grip is configured to be entirely removed from the fiber optic cable by accessing only the distribution end of the cable. This means an operator does not need access to the furcation or other locations along the length of the fiber optic cable to remove the pulling grip assembly. Instead, the pulling grip assembly may be removed from the fiber optic cable without requiring additional steps, such as accessing the pathway through which the cable was pulled, for example. To that end, the pulling grip may be removed from the deployed location or ground level where the distribution end of the fiber optic cable is pulled and where the equipment is located to which one or more subunits of the fiber optic cable will be connected, thus greatly improving the efficiency of a cable pulling and installation operation. These and other benefits of the disclosure will be described more fully below.

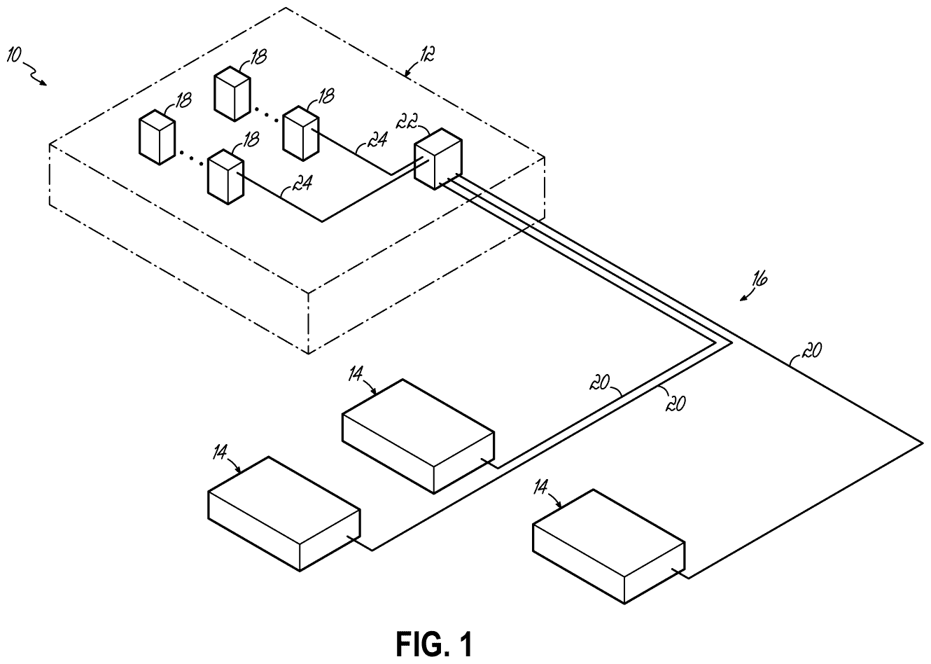

Turning now to the Figures, and FIG. 1 in particular, a modern-day data center 10 may include a collection of buildings (referred to as a data center campus) having, for example, a main building 12 and one or more auxiliary buildings 14 in close proximity to the main building 12. While three auxiliary buildings 14 are shown, there may be more or less depending on the size of the campus. The data center 10 provides for a local fiber optic network 16 that interconnects the auxiliary buildings 14 with the main building 12. The local fiber optic network 16 allows network equipment 18 in the main building 12 to communicate with various network equipment (not shown) in the auxiliary buildings 14. In the exemplary embodiment shown, the local fiber optic network 16 includes trunk cables 20 extending between the main building 12 and each of the auxiliary buildings 14. Conventional trunk cables 20 generally include a high fiber-count arrangement of optical fibers for passing data and other information through the local fiber optic network 16. In the example illustrated in FIG. 1, the trunk cables 20 from the auxiliary buildings 14 are routed to one or more distribution cabinets 22 housed in the main building 12 (one shown).

Within the main building 12, a plurality of indoor fiber optic cables 24 are routed between the network equipment 18 and the one or more distribution cabinets 22. The indoor cables 24 generally include a high fiber-count arrangement of optical fibers for passing data and other information from the distribution cabinets 22 to the network equipment 18. Although only the interior of the main building 12 is schematically shown in FIG. 1 and discussed above, each of the auxiliary buildings 14 may house similar equipment for similar purposes. Thus, although not shown, each of the trunk cables 20 may be routed to one or more distribution cabinets 22 in one of the auxiliary buildings 14 in a manner similar to that described above. Furthermore, each of the auxiliary buildings 14 may include indoor cables 24 that extend between network equipment 18 and the one or more distribution cabinets 22 of the auxiliary building 14.

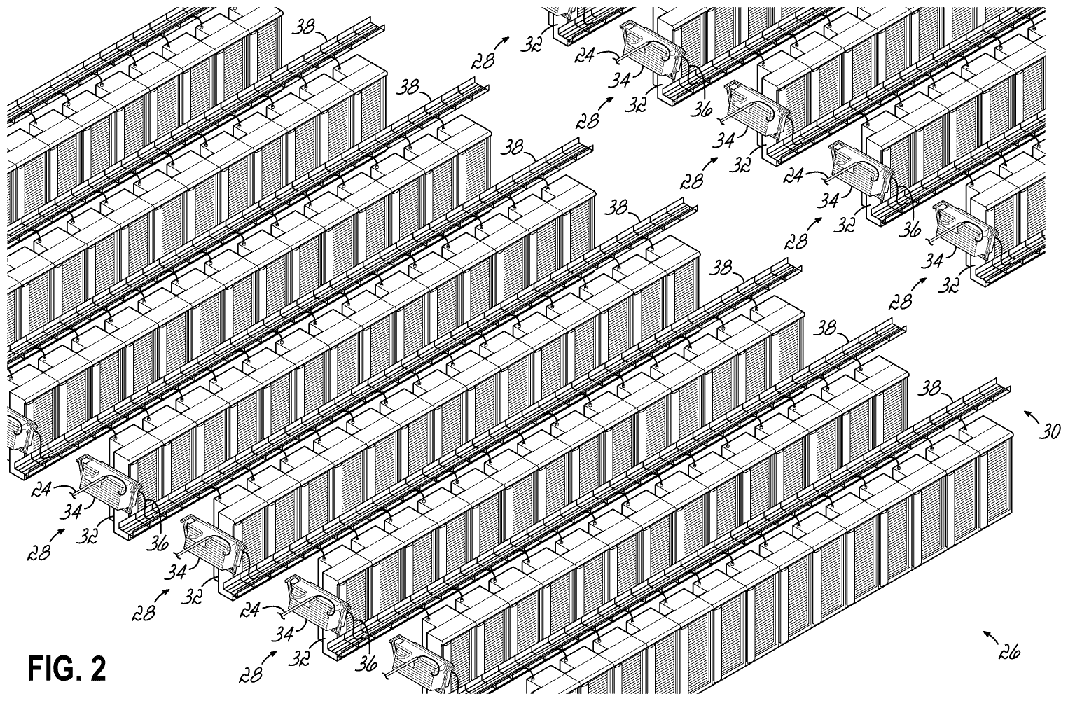

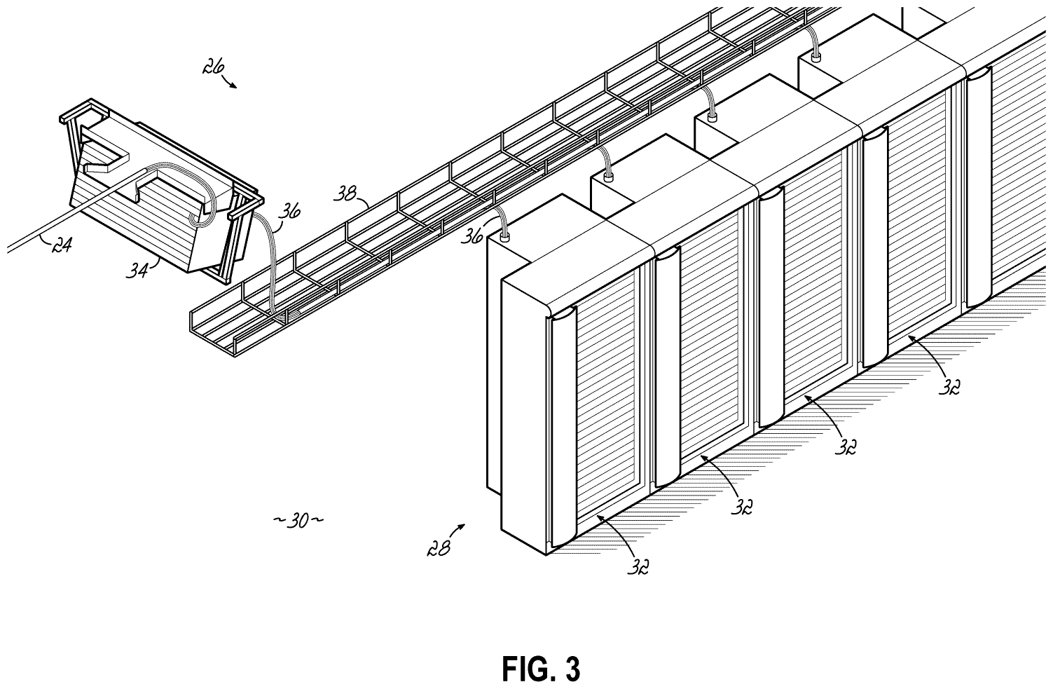

As illustrated in more detail in FIGS. 2 and 3, the network equipment 18 in the main building 12 or an auxiliary building 14 may be arranged in one or more data halls 26 that generally include a plurality of spaced-apart rows 28 on one or both sides of an access pathway 30. The arrangement of the data halls 26 into rows 28 helps organize the large number of equipment, fiber optic cables, fiber optic connections, etc. Each of the rows 28 includes a plurality of equipment racks (or cabinets) 32 generally arranged one next to the other along the row 28. Each of the equipment racks 32 is a vertically arranged framework for holding various network equipment 18 of the data center 10, as is generally known in the telecommunications industry. In one common arrangement, and as further illustrated in FIG. 2, each row 28 may include an intermediate distribution frame 34 at the head end of the row 28 closest to the access pathway 30.

The intermediate distribution frame 34 represents a termination point of at least some of the optical fibers carried by one or more of the indoor cables 24, for example. Although the intermediate distribution frame 34 is shown as being positioned above the row 28, in other embodiments the intermediate distribution frame 34 may be in a cabinet (not shown) at the head end of the row 28 or in the first equipment rack 32 at the head end of the row 28. In yet other embodiments, the intermediate distribution frame 34 may be located within the associated row 28, such as in the middle of the row 28, and be above, below, or within one of the equipment racks 32. In a conventional arrangement, one or more distribution cables 36 are connected to the intermediate distribution frame 34 of a row 28 and routed along a cable tray 38 generally disposed above the row 28. The network equipment 18 in the equipment racks 32 is then optically connected to the one or more distribution cables 36 to provide the interconnectivity of the network equipment 18 (e.g., equipment racks 32) of the data center 10.

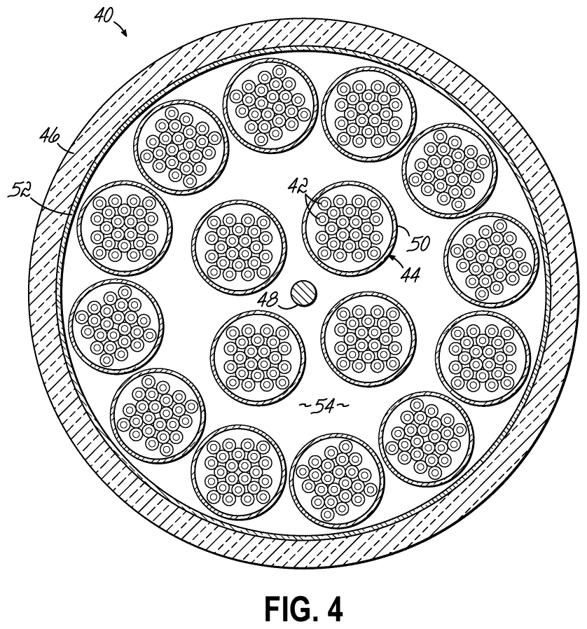

Referring now to FIG. 4, a fiber optic cable 40 generally includes a high fiber-count arrangement of optical fibers 42 for passing data and other information through the local fiber optic network 16. The fiber optic cable 40 may be a row distribution cable 36, described above. Further, aspects of the disclosure may also prove beneficial to an indoor cable 24 or a trunk cable 20, also described above. Regardless, the number of optical fibers 42 carried by the fiber optic cable 40 and how the optical fibers 42 are arranged within the fiber optic cable 40 may vary based on the application. The fiber optic cable 40 in the depicted embodiment includes a plurality of routable subunits 44, otherwise referred to as cable legs, and each routable subunit 44 is configured to carry a pre-selected number of optical fibers 42. Although the fiber optic cable 40 is shown as including sixteen routable subunits 44, the number of subunits 44 may be more or less than this number in alternative embodiments. The routable subunits 44 may be arranged within an outer protective sheath or outer jacket 46, as is generally known in the industry.

The fiber optic cable 40 generally includes at least one strength member 48 that extends along a length of the fiber optic cable 40 and provides tensile strength to the fiber optic cable 40 during installation of the fiber optic cable 40 in a pathway (e.g., an indoor/outdoor conduit or duct, a cable tray 38, etc.) of the fiber optic network. In the exemplary embodiment shown, the strength member 48 is located within the fiber optic cable 40 among the subunits 44. However, it is to be understood that one or more strength members 48 could be located in alternative locations in the fiber optic cable 40 (e.g., in the outer jacket 46). Each of the routable subunits 44 is configured to carry a pre-selected number of optical fibers 42. By way of example and without limitation, each routable subunit 44 may be configured to carry 24 optical fibers 42. It should be recognized, however, that more or less optical fibers 42 may be carried by each of the routable subunits 44. In one embodiment, the optical fibers 42 may be loosely held within an outer subunit sheath or jacket 50 of each subunit.

With continuing reference to FIG. 4, a strain-relief element 52 may be disposed in an interior 54 of the cable adjacent jacket 46 and surrounding the subunits 44. Strain-relief element 52 may include, for example, a layer of yarn or yarns (e.g. aramid yarn) for absorbing tensile loads. The strain-relief element 52 is shown with a uniform thickness, however, the strain relief element 52 may have a non-uniform thickness because the locations of the subunits 44 or other internals of the cable 40 may cause the strain-relief element 52 to compress at various locations along the length of the cable 40.

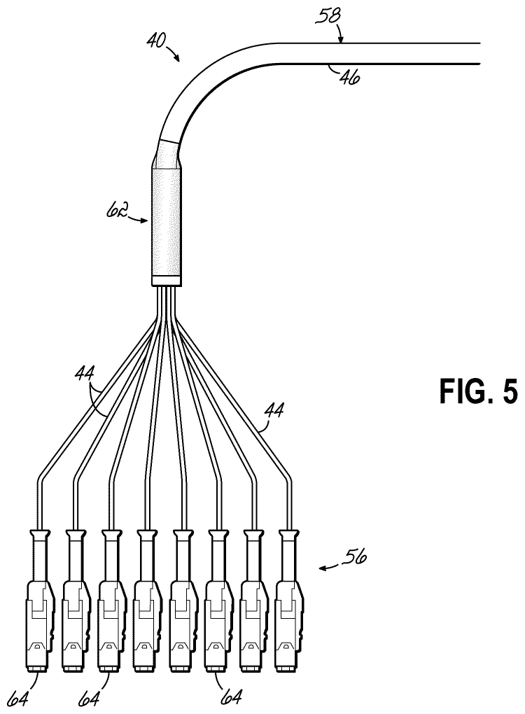

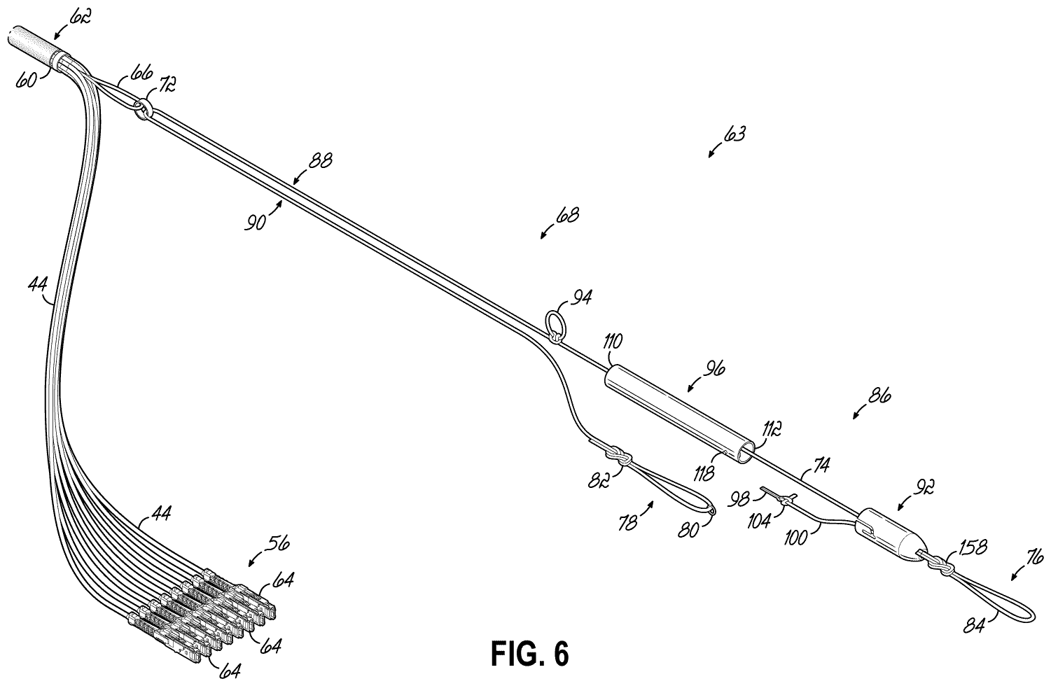

Referring now to FIG. 5, the fiber optic cable 40 has a distribution end 56, a main cable section 58, and a terminal end (not shown) opposite the distribution end 56. As will be described in further detail below, the fiber optic cable 40 includes a pulling grip assembly attachable to the distribution end 56 for pulling the fiber optic cable 40 through a pathway during a cable pulling operation, for example. The fiber optic cable 40 and the pulling grip assembly may together form a fiber optic cable assembly 63 (e.g., FIG. 6). However, the distribution end 56 of the fiber optic cable is shown without the pulling grip assembly in FIG. 5. Further, only a portion of the main cable section 58 is shown in FIG. 5, and in some embodiments the terminal end may have a configuration similar to the distribution end 56 such that discussion of the distribution end 56 may equally apply to the terminal end in such embodiments. However, embodiments are also possible where the terminal end has a configuration different than the distribution end 56.

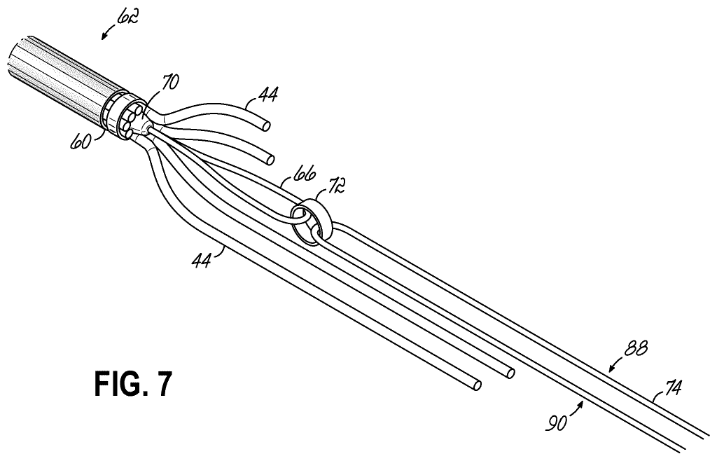

With continued reference to FIG. 5, to prepare the fiber optic cable 40 for installation through a pathway, the outer jacket 46 may be removed or stripped to expose a working length of the optical fibers 42 and routable subunits 44, forming a jacket end 60 of the fiber optic cable 40 (e.g., FIGS. 6 and 7). Proximate the jacket end 60 of the fiber optic cable 40 is a furcation 62 through which the routable subunits 44 pass through and extend to a respective terminal end. The end of each subunit 44 may include a connector 64 on the end, such as at least one multifiber connector. The fiber optic cable 40 may be considered a pre-connectorized cable with connectorized subunits 44. Eight subunits 44 are shown in FIG. 5 by way of illustration. However, the fiber optic cable 40 may include fewer or more routable subunits 44 as needed. The exposed lengths and connectors of each subunit 44 may be enclosed in a sleeve attached to the pulling grip assembly for a cable pulling operation, as will be described in further detail below.

The furcation 62 may be a region where subunits 44 exiting from the fiber optic cable 40 enter into another fiber optic cable (e.g., fanout leg, furcation legs, cable legs). In this configuration, the subunits 44 may be butt-jointed together at the furcation 62, where the strength element of each subunit 44 may be exposed and mechanically coupled between the butt-joints. The furcation 62 may also be a pass-through furcation where one or more subunits 44 pass through the furcation 62. In either case, as will be understood by a person skilled in the art, the furcation 62 is a region where tensile loads imposed on the fiber optic cable 40, such as via the pulling grip assembly, are transferred to the strength element 48 of the fiber optic cable 40, ensuring that the individual fibers of each subunit 44 are protected from stress and potential damage during a cable pulling operation.

Referring now to FIGS. 6 and 7, the fiber optic cable 40 includes a pulling loop 66 extending from the jacket end 60 of the fiber optic cable 40. The pulling loop 66, otherwise referred to as a pulling eye, serves as an anchor point to which a load-bearing pulling grip assembly 68 may be attached, allowing the fiber optic cable 40 to be safely pulled through a pathway by the pulling grip assembly 68. As shown in FIG. 7, the pulling loop 66 may be secured to a furcation body 70 of the furcation 62. However, the pulling loop 66 may either be directly or indirectly connected to the strength member 48 of the fiber optic cable 40. In that regard, the pulling loop 66 is configured to transfer tensile loads imposed on the pulling grip assembly 68 to the furcation 62 and/or the strength member 48 of the fiber optic cable 40. The pulling loop 66 may be made from a flexible, tensile load-bearing material, such as paracord, fishing line, or monofilament, for example. In another embodiment, the pulling loop 66 may be formed from the strength member 48 disposed in the fiber optic cable 40, and referred to as a strength member pulling loop. In either case, the pulling loop 66 may include an eyelet 72 through which a portion of the pulling grip assembly 68 is configured to be routed to attach the pulling grip assembly 68 to the pulling loop 66. The eyelet 72 may be a circular or oval metal or plastic ring, for example, that generally maintains its ring shape during use, allowing components of the pulling grip assembly 68 to pass through the eyelet 72 for removing the pulling grip assembly 68 from the fiber optic cable 40, as will be described in further detail below.

With reference to FIG. 6, the pulling grip assembly 68 is shown in accordance with one embodiment of the disclosure. The pulling grip assembly 68 includes a flexible line 74 that extends a length from a gripping end 76 of the flexible line 74 to an opposite attachment end 78 of the flexible line 74. The flexible line 74 may be a flexible or semi-rigid, tensile load-bearing material, such as paracord, fishing line, or monofilament, for example. The attachment end 78 of the flexible line 74 includes a coupler 80, which may be in the form of a metal or plastic ring. The coupler 80 may be secured to the attachment end 78 of the flexible line 74 with a knot 82, for example. The gripping end 76 of the flexible line 74 includes a handle 84 and a quick release assembly 86 that is configured to receive the coupler 80 to releasably connect the attachment end 78 of the flexible line 74 to the gripping end 76 of the flexible line 74.

As shown in FIG. 6, the flexible line 74 is configured to be looped or routed through the pulling loop 66, and in particular the eyelet 72 of the pulling loop 66, to secure the pulling grip assembly 68 to the fiber optic cable 40. Once routed through the eyelet 72 of the pulling loop 66, the flexible line 74 is generally folded back on itself to define a first cordage leg 88 and a second cordage leg 90 of the flexible line 74, with the gripping end 76 of the flexible line 74 and the attachment end 78 of the flexible line 74 being located at the distribution end 56 of the fiber optic cable 40. In that regard, the length of the flexible line 74 is longer compared to a length of each subunit 44 that is exposed from the jacket end 60 of the fiber optic cable 40. Each cordage leg 88, 90 may have a length that is generally half of the length of the flexible line 74, as shown. The cordage legs 88, 90 extend between the distribution end 56 of the fiber optic cable 40 and the pulling loop 66, running along each of the exposed lengths of the subunits 44. To that end, tensile loads imposed on the pulling grip assembly 68, such as via the handle 84, are distributed through both cordage legs 88, 90 (nominally even) and transferred to the pulling loop 66 of the fiber optic cable 40 along a load path that bypasses the exposed lengths and connectors 64 of each subunit 44. This minimizes the risk of damaging the fiber optic cable 40, and in particular the subunits 44, during a cable pulling operation.

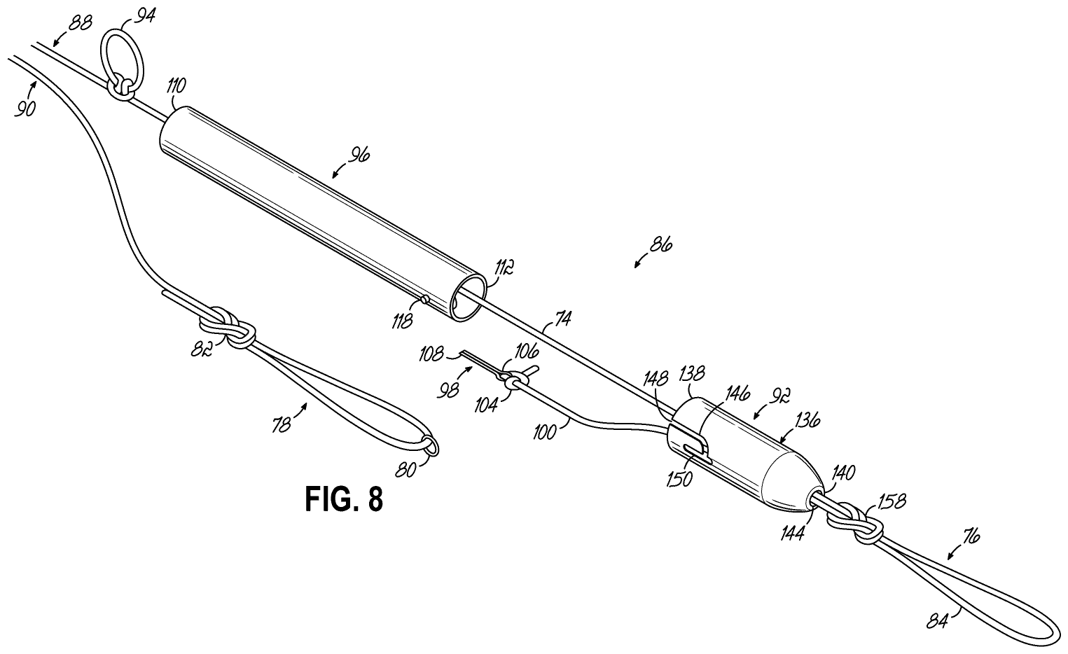

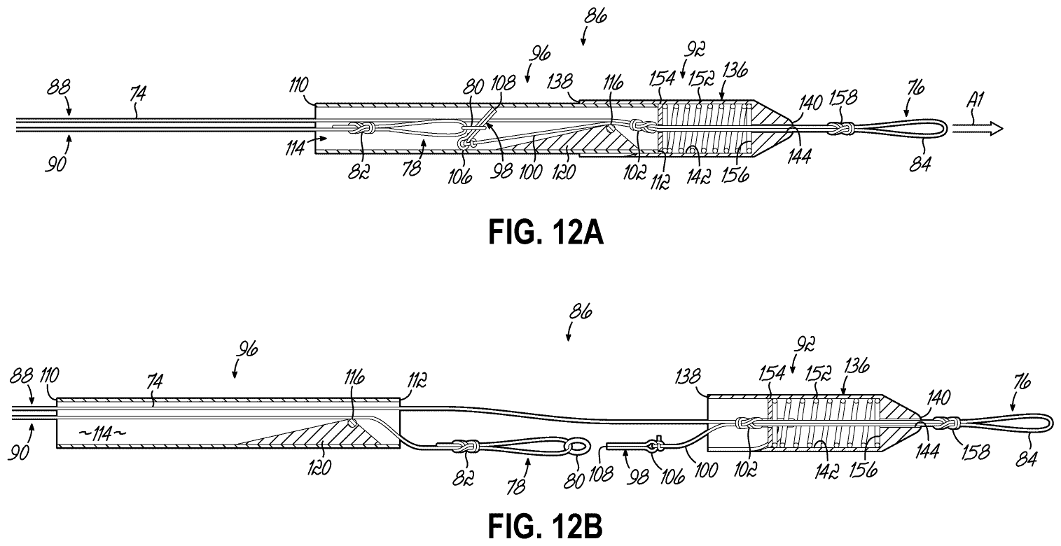

Referring now to FIG. 8, the quick release assembly 86 includes a cap 92 secured to the gripping end 76 of the flexible line 74 adjacent the handle 84, a stopper 94 secured to the gripping end 76 of the flexible line 74 a distance from the cap 92, and a locking tube 96 slideably arranged on the gripping end 76 of the flexible line 74 between the cap 92 and the stopper 94. The locking tube 96 is slidable along the flexible line 74 but is held captive between the stopper 94 and the cap 92. In particular, the locking tube 96 is slideable along the flexible line 74 between a connected position in which the locking tube 96 is selectively coupled to the cap 92 (e.g., FIG. 12A) and a released position in which the locking tube 96 is decoupled from the cap 92 (e.g., FIG. 12B). Both the stopper 94 and the cap 92 are securely fastened to the flexible line 74 such that there is little to no movement of those parts along the length of the flexible line 74. The quick-release assembly 86 also includes a locking member 98 attached to the gripping end 76 of the flexible line 74 with a tether 100.

As briefly described above, the flexible line 74 of the pulling grip assembly 68 is configured to be routed through the pulling loop 66, with both the gripping end 76 and the attachment end 78 remaining at the distribution end 56 of the fiber optic cable 40. The quick-release assembly 86 is configured to receive the coupler 80 to releasably connect the attachment end 78 of the flexible line 74 to the gripping end 76 of the flexible line 74. Specifically, the coupler 80 at the attachment end 78 of the flexible line 74 and the locking member 98 are configured to be releasably connected together within the locking tube 96 when the locking tube 96 is in the connected position to transfer the tensile load imposed on the pulling grip assembly 68 to the fiber optic cable 40. The attachment end 78 of the flexible line 74 may remain coupled to the gripping end 76 of the flexible line 74 during a cable pulling operation in which the fiber optic cable assembly 63 is pulled using the handle 84 of the pulling grip assembly 68. When the locking tube 96 is decoupled from the cap 92 (i.e., the locking tube 96 is moved to the released position), the coupler 80 and the locking member 98 decouple, separating the gripping end 76 from the attachment end 78 of the flexible line 74, and allowing the entire pulling grip assembly 68 to slide off the distribution end 56 of the fiber optic cable 40. Having generally described the operation of the pulling grip assembly 68, each component of the pulling grip assembly 68 will now be described in greater detail below.

With continued reference to FIG. 8, the tether 100 attaching the locking member 98 to the gripping end 76 of the flexible line 74 is fixed at a location therealong with a tether knot 102. The tether knot 102 is generally positioned between the locking tube 96 and the cap 92. In the embodiment shown, the tether knot 102 is positioned within the cap 92. The locking member 98 may be attached to a free end of the gripping end 76 of the flexible line 74 with a knot 104, as shown. That is, a portion of the free end of the gripping end 76 of the flexible line 74 may form the tether 100. In an alternative embodiment, the locking member 98 may be secured to the gripping end 76 of the flexible line 74 with a separate flexible line that is tied or otherwise secured to the flexible line 74. In either case, the locking member 98 may be in the form of a cotter pin or machine pin, for example. In that regard, the locking member 98 extends between a head 106 and a tip end 108, with the tether 100 being attached to the head 106 of the locking member 98.

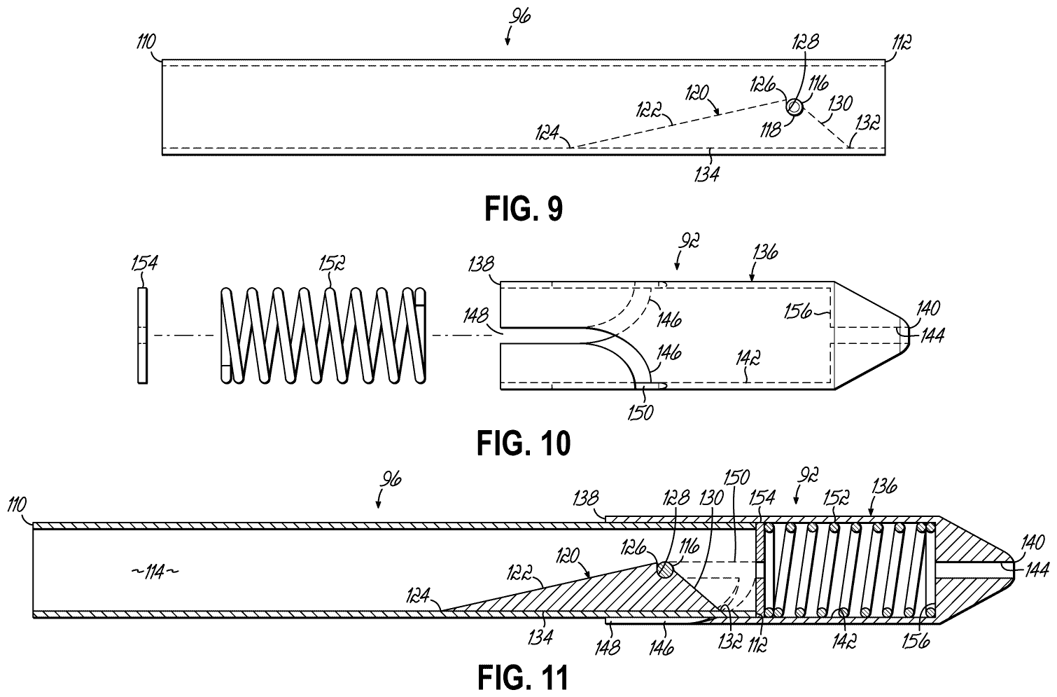

Referring to FIGS. 8 and 9, the locking tube 96 extends a length between a first end 110 and an opposite second end 112 and includes a hollow interior 114. The flexible line 74 of the pulling grip assembly 68 is configured to be routed through the hollow interior 114 of the locking tube 96, allowing the locking tube 96 to slide along the flexible line 74. The second end 112 of the locking tube 96 includes a pin or dowel 116 that extends through the locking tube 96 to form a pair of external projections 118 arranged opposite each other around the circumference of the locking tube 96. In the embodiment shown, the projections 118 are the ends of the pin 116. However, in an alternative embodiment without a pin 116, the projections 118 may be separate parts of the locking tube 96. In either case, the pair of projections 118 are configured to engage the cap 92 to selectively couple the locking tube 96 to the cap 92, as will be described in further detail below.

The locking tube 96 further includes a ramp 120 arranged within the interior 114 and proximate to the second end 112 of the locking tube 96. As shown, the ramp 120 includes a first sloped surface 122 that inclines from a first end 124 of the ramp 120 to an apex 126 of the ramp 120 aligned with the pin 116 through the locking tube 96. The ramp, and in particular the first sloped surface 122 gradually increases in height from the first end 124 of the ramp 120, which is generally flush with the interior surface of the locking tube 96, to the apex 126 of the ramp 120, which is spaced a distance from the interior surface of the locking tube 96. At the apex 126, the ramp 120 includes a channel 128 configured to receive the pin 116. The engagement between the pin 116 and the channel 128 couples the ramp 120 to the locking tube 96. The ramp 120 may also include a second sloped surface 130 that extends from the apex 126 to a second end 132 of the ramp 120. The slope of this second sloped surface 130 may be steeper compared to the slope of the first sloped surface 122. The first and second ends 124, 132 of the ramp 120 are where the first sloped surface 122 and the second sloped surface 130, respectively, intersect a base 134 of the ramp 120. The purpose of the ramp 120 is to allow the locking member 98 to pass over the pin 116 without becoming hooked or locked around it, thus preventing any obstruction when disconnecting the pulling grip assembly 68 from the fiber optic cable 40.

Referring now to FIGS. 10 and 11, the cap 92 includes a generally tubular body 136 that extends a length from a base 138 of the cap 92 to a tip 140. The cap 92 includes a socket 142 with an opening to the socket 142 at the base 138 of the cap 92. The tip 140 of the cap 92 includes a bore 144 that extends from an opening at the tip 140 to the socket 142 so that the flexible line 74 may be routed through the cap 92 via the socket 142 and bore 144 (e.g., FIGS. 12A and 12B). The socket 142 of the cap 92 is configured to receive the second end 112 of the locking tube 96 to selectively couple the locking tube 96 to the cap 92. In that regard, the cap 92 includes a pair of bayonet slots 146 arranged opposite each other around the circumference of the cap 92, which hereinafter will be referred to as “bayonet cap 92”. Each bayonet slot 146 is configured to receive one of the external projections 118 of the locking tube 96, allowing for the selective coupling of the locking tube 96 to the bayonet cap 92. Each bayonet slot 146 extends from an opening 148 at the base 138 of the bayonet cap 92, and follows a curved path in an axial direction away from the base 138 towards the tip 140 of the bayonet cap 92, while slightly turning radially around the circumference of the bayonet cap 92. In that regard, the bayonet slots 146 turn in opposite radial directions around the circumference of the bayonet cap 92, requiring a twisting motion to couple and decouple the locking tube 96 to the bayonet cap 92, as will be described in further detail below. Each bayonet slot 146 terminates at a catch 150, which is a section of the bayonet slot 146 that extends sharply back towards the base 138 of the bayonet cap 92 in an axial direction. The catch 150 may form a generally “T” shaped section of the bayonet slot 146. Each catch 150 is configured to receive a respective external projection 118 of the locking tube 96 to maintain the connected position of the locking tube 96 to the bayonet cap 92. In alternative embodiments, the cap 92 may be configured to be selectively coupled to the locking tube 96 by other techniques, such as those involving fasteners, threaded connections, etc.

The bayonet cap 92 is configured to receive a spring 152, such as a coil spring, and a washer 154 within the socket 142. As shown in FIGS. 11-12B, the spring 152 is disposed in the socket 142 and held captive between a base 156 of the socket 142 and the washer 154 which is also disposed in the socket 142. In particular, the spring 152 and washer 154 are held captive within the socket 142 and between the tether knot 102 and the base 156 of the socket 142. The flexible line 74 is configured to be routed through the bore 144 of the bayonet cap 92, the spring 152, the washer 154, and out of the bayonet cap 92 via the socket 142. The stack up that is the bayonet cap 92, the spring 152, and the washer 154 are held in place along the gripping end 76 of the flexible line 74 by the tether knot 102 and a handle knot 158. That is, the bayonet cap 92, the spring 152, and the washer 154 are held captive between the tether knot 102 and the handle knot 158.

As briefly described above, the socket 142 of the bayonet cap 92 is configured to receive the second end 112 of the locking tube 96 so that the locking tube 96 may be selectively coupled to the bayonet cap 92, as shown in FIG. 11. Specifically, the pair of external projections 118 on the locking tube 96 are configured to be received within respective bayonet slots 146 on the bayonet cap 92 as the second end 112 of the locking tube 96 is received into the socket 142. As the second end 112 of the locking tube 96 is inserted into the socket 142, it engages the washer 154, compressing the spring 152. The spring 152 is compressed until the external projections 118 reach the catch 150 of each bayonet slot 146, at which point the locking tube 96 may be twisted or rotated and then released. The spring 152, acting against the washer 154, biases the locking tube 96 out of the socket 142, thus pushing each of the external projections 118 into a respective catch 150 to maintain the connected position of the locking tube 96 to the bayonet cap 92, as shown in FIG. 11.

Having now described certain details of the fiber optic cable 40 and the pulling grip assembly 68, a method of attaching the pulling grip assembly 68 to the fiber optic cable 40 to form the fiber optic cable assembly 63 for pulling through a pathway will now be described. In that regard, and with reference to FIG. 6, in preparation to set or install the pulling grip assembly 68, the flexible line 74 is first routed through the pulling loop 66 and the gripping end 76 and the attachment end 78 of the flexible line 74 arranged at the distribution end 56 of the fiber optic cable 40. When so arranged, the coupler 80 is ready to be releasably coupled to the quick release assembly 86 to connect the attachment end 78 of the flexible line 74 to the gripping end 76 of the flexible line 74.

With reference to FIGS. 12A and 12B, the coupler 80 and the attachment end 78 of the flexible line 74 are routed through the first end 110 of the locking tube 96 and out through the second end 112 to a position as generally shown in FIG. 12B. The locking member 98 may then be inserted through the coupler 80. In that regard, the coupler 80 may be slid onto the locking member 98 to a position generally adjacent to the head 106 of the locking member 98. The locking member 98 may then be carefully tilted away from the second end 112 of the locking tube 96 while the head 106 of the locking member 98 and the coupler 80 are fed into the second end 112 of the locking tube 96 and past the apex 126 of the ramp 120. Simultaneously, the locking tube 96 is slid toward the bayonet cap 92 and over the locking member 98 and the coupler 80 to receive the locking member 98 and the coupler 80 into the interior 114 of the locking tube 96. The locking tube 96 is then further slid along the flexible line 74 and coupled with the bayonet cap 92, placing the locking tube 96 in the connected position as shown in FIG. 12A. Connecting the locking tube 96 to the bayonet cap 92 involves several steps as described above. First, aligning the pair of external projections 118 of the locking tube 96 with the pair of bayonet slots 146. Next, inserting the second end 112 of the locking tube 96 into the socket 142 of the bayonet cap 92 to compress the spring 152. Then, twisting the locking tube 96 to position each of the external projections 118 into respective catches 150 of the bayonet slots 146. Finally, releasing the locking tube 96, allowing the spring 152 to push the projections 118 into the catches 150, securing the locking tube 96 in the connected position.

When in the connected positioned, as shown in FIG. 12A, the coupler 80 at the attachment end 78 of the flexible line 74 is received into the locking tube 96 from the first end 110 and releasably connected to the locking member 98 that is received into the locking tube 96 from the second end 112. In that regard, the gripping end 76 of the flexible line 74 is prevented from decoupling from the attachment end 78 because the coupler 80 cannot slide off the locking member 98. This is a result of the locking member 98 being unable to rotate lengthwise within the interior 114 of the locking tube 96. The length of the locking member 98 is greater than the inner diameter of the locking tube 96, preventing it from rotating lengthwise inside the locking tube 96, thus maintaining the connection between the coupler 80 and the locking member 98.

A tensile load, as indicated by directional arrow A1, may be applied to the pulling grip assembly 68 once the pulling grip assembly 68 is placed in the connected position to pull or route the fiber optic cable assembly 63 through a pathway. In that regard, the pulling grip assembly 68 directs the tensile load to the strength member 48 of the fiber optic cable 40 along a load path that bypasses the fiber optic connector 64 of the subunits 44, as described above. Once the fiber optic cable assembly 63 has been pulled to a desired location, such as the deployed location near equipment where the subunits 44 of the fiber optic cable 40 may be connected, the pulling grip assembly 68 may be removed from the fiber optic cable 40 in a tool-less manner.

To remove the pulling grip assembly 68 from the fiber optic cable 40, the locking tube 96 must first be released or decoupled from the bayonet cap 92. To do this, the locking tube 96 is pressed into the bayonet cap 92 to compress the spring 152. The locking tube 96 may then be twisted to move the pair of external projections 118 out of the catch 150 of a respective bayonet slot 146. At this point, the locking tube 96 may be released or pulled away from the bayonet cap 92. Specifically, the locking tube 96 is slid along the flexible line 74 away from the bayonet cap 92 to remove the second end 112 of the locking tube 96 from the socket 142 of the bayonet cap 92. As the locking tube 96 is slid away from the bayonet cap 92 toward the stopper 94 to the released position, the locking member 98 and the coupler 80 move along the first sloped surface 122 of the ramp 120, over the apex 126, and past the pin 116. The locking member 98 remains in a tilted position during this movement. Once the coupler 80 and the locking member 98 exit from the locking tube 96 at the second end 112, the locking member 98 is free to rotate, allowing the coupler 80 to slide off the tip end 108 of the locking member 98, as shown in FIG. 12B. This decouples the attachment end 78 of the flexible line 74 from the gripping end 76. As shown, the coupler 80 and the locking member 98 are removed from the interior 114 of the locking tube 96 when the locking tube 96 is in the released position. At this point, the pulling grip assembly 68 may be pulled away from the fiber optic cable 40, using the handle 84, for example, to slide the entire pulling grip assembly 68 off the fiber optic cable 40. As the pulling grip assembly 68 is removed, the attachment end 78 of the flexible line 74 passes through the eyelet 72 of the pulling loop 66, permitting the pulling grip assembly 68 to be removed from the fiber optic cable 40 as a single piece.

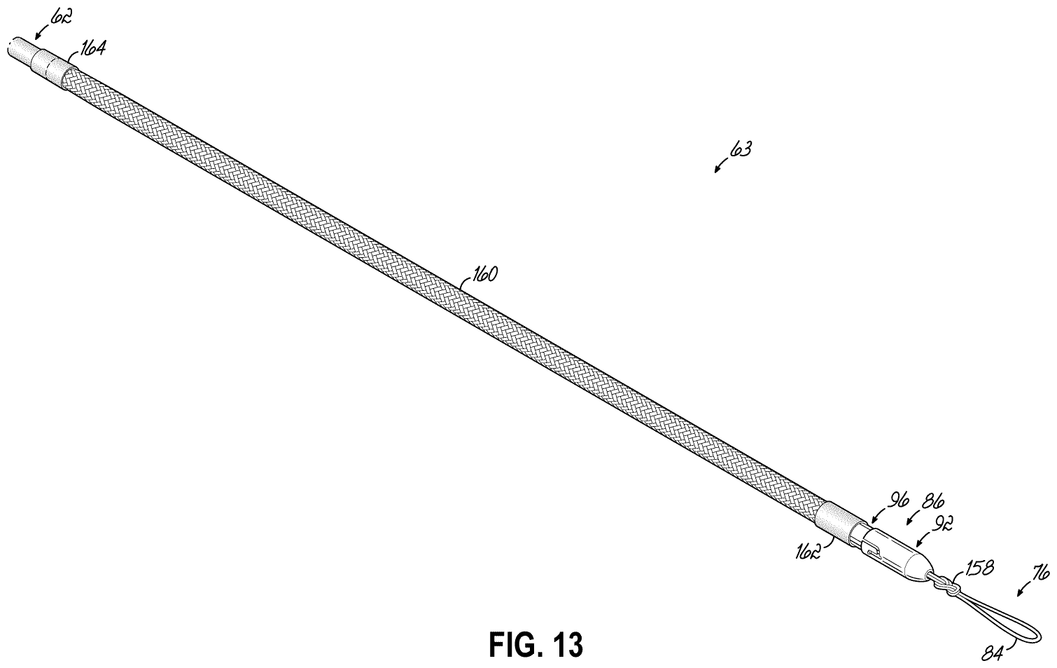

Turning now to FIG. 13, a fiber optic cable assembly 63 is shown according to one embodiment of the disclosure, including a sleeve 160, such as an expandable mesh sleeving, which is slid over the cordage legs 88, 90 of the flexible line 74 and the exposed lengths and connectors 64 of each subunit 44, allowing the subunits 44 and the cordage legs 88, 90 to freely suspend inside the sleeve 160. That is, the subunits 44 and the cordage legs 88, 90 are covered and enclosed within the sleeve 160. The sleeve 160 may be permanently secured at one end to the locking tube 96 of the pulling grip assembly 68 with a heat shrink 162 or other fasteners/techniques. In this regard, the sleeve 160 is considered part of the pulling grip assembly 68. The heat shrink 162, in combination with the stopper 94, ensures that the entire pulling grip assembly 68 remains a single piece when removed and discarded, for example, saving the operator time and enabling a cleaner fiber optic cable 40 installation.

As the pulling grip assembly 68 is removed from the fiber optic cable 40, as described above, the sleeve 160 is also slid off the fiber optic cable 40 to expose the subunits 44 and connectors 64. In that regard, the second end of the sleeve 160 may be releasably secured to the main cable section 58 of the fiber optic cable 40 with a temporary shrink tube 164 that is configured to tear and break away when the sleeve 160 is pulled away from the fiber optic cable 40 during the removal of the pulling grip assembly 68. The temporary shrink tube 164 may include perforations or other suitable features that facilitate its breaking away during the removal process.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

What is claimed is:

1. A fiber optic cable assembly, comprising:
a fiber optic cable including a distribution end and an outer jacket that defines a cable interior that includes at least one strength member and a plurality of subunits each containing at least one optical fiber terminated by a fiber optic connector at the distribution end of the fiber optic cable, the outer jacket having an end through which each of the plurality of subunits extends to the fiber optic connector;
a pulling loop spaced from or extending beyond the end of the outer jacket, wherein the pulling loop is coupled to or defined by a portion of the at least one strength member;
a pulling grip assembly, comprising:
a flexible line that extends a length from a gripping end to an opposite attachment end;
a coupler at the attachment end of the flexible line; and
a quick release assembly at the gripping end of the flexible line, the quick release assembly being configured to receive the coupler to releasably connect the attachment end of the flexible line to the gripping end of the flexible line;
wherein the flexible line is routed through the pulling loop with the attachment end and the gripping end of the flexible line being connected together at the distribution end of the fiber optic cable such that a tensile load imposed on the pulling grip assembly is transferred through the pulling loop to the strength member of the fiber optic cable along a load path that bypasses the fiber optic connector of each of the plurality of subunits.

2. The fiber optic cable assembly of claim 1, wherein the quick release assembly further comprises:
a cap secured to the gripping end of the flexible line;
a locking tube that includes a length between a first end and an opposite second and a hollow interior, the locking tube being slidably arranged on the flexible line and slideable along the flexible line between a connected position in which the locking tube is selectively coupled to the cap and a released position in which the locking tube is decoupled from the cap; and
a locking member tethered to the gripping end of the flexible line at a location therealong between the locking tube and the cap;
wherein the coupler at the attachment end of the flexible line and the locking member are configured to be releasably connected within the interior of the locking tube when the locking tube is in the connected position to transfer the tensile load imposed on the pulling grip to the fiber optic cable, and wherein the coupler and the locking member are configured to decouple when the locking tube is moved to the released position.

3. The fiber optic cable assembly of claim 2, wherein the coupler at the attachment end of the flexible line is received into the locking tube from the first end and releasably connected to the locking member that is received into the locking tube from the second end when the locking tube is in the connected position.

4. The fiber optic cable assembly of claim 2, wherein the coupler and the locking member are removed from the interior of the locking tube when the locking tube is in the released position.

5. The fiber optic cable assembly of claim 2, wherein the locking member is a pin that includes a length, the length of the pin being greater than an inner diameter of the locking tube.

6. The fiber optic cable assembly of claim 2, wherein the cap includes a socket and an opening to the socket at a base of the cap, the socket being configured to receive the second end of the locking tube to selectively couple the locking tube to the cap.

7. The fiber optic cable assembly of claim 6, wherein the second end of the locking tube includes a pair of external projections arranged opposite each other about a circumference of the locking tube, the pair of external projections being configured to engage the cap to selectively couple the locking tube to the cap.

8. The fiber optic cable assembly of claim 7, wherein the cap includes a pair of bayonet slots arranged opposite each other about a circumference of the cap, each of the pair of bayonet slots being configured to receive one of the pair of external projections to selectively couple the locking tube to the cap.

9. The fiber optic cable assembly of claim 8, wherein each of the pair of bayonet slots includes a catch, and the cap includes a spring disposed in the socket, the spring being configured to bias each of the pair of external projections into the catch of one bayonet slot to maintain the connected position of the locking tube.

10. The fiber optic cable assembly of claim 6, wherein the pair of external projections are part of a same pin that extends through the locking tube.

11. The fiber optic cable assembly of claim 10, wherein the locking tube includes a ramp arranged within the interior of the locking tube proximate to second end of the locking tube, and wherein the ramp gradually increases in height along a length of the ramp from a first end to an apex at the pin.

12. The fiber optic cable assembly of claim 2, wherein the quick release assembly further comprises a stopper attached to the gripping end of the flexible line and spaced a distance from the cap, and wherein the locking tube is held captive between the stopper and the cap.

13. The fiber optic cable assembly of claim 1, wherein the pulling grip assembly further comprises a sleeve attached at one end to the locking tube, the sleeve being configured to cover the plurality of subunits.

14. A method of attaching a pulling grip assembly to a fiber optic cable to form a fiber optic cable assembly, the fiber optic cable including a distribution end and an outer jacket that defines a cable interior that includes at least one strength member and a plurality of subunits each containing at least one optical fiber terminated by a fiber optic connector at the distribution end of the fiber optic cable, the outer jacket having an end through which each of the plurality of subunits extends to the fiber optic connector, the method comprising:
providing a pulling loop spaced from or extending beyond the end of the outer jacket, wherein the pulling loop is coupled to or defined by a portion of the at least one strength member;
providing the pulling grip assembly, comprising:
a flexible line that extends a length from a gripping end to an opposite attachment end;
a coupler at the attachment end of the flexible line; and
a quick release assembly at the gripping end of the flexible line;
routing the flexible line through the pulling loop;
arranging the gripping end and the attachment end of the flexible line at the distribution end of the fiber optic cable; and
connecting the quick release assembly to the coupler to releasably connect the attachment end of the flexible line to the gripping end of the flexible line.

15. The method of claim 14, wherein the quick release assembly further comprises a cap secured to the gripping end of the flexible line, a locking tube that includes a length between a first end and an opposite second and a hollow interior, the locking tube being slidably arranged on the flexible line, and a locking member tethered to the gripping end of the flexible line at a location therealong between the locking tube and the cap, the method further comprising:
sliding the locking tube along the flexible line and coupling the locking tube with the cap to place the locking tube in a connected position.

16. The method of claim 15, further comprising:
receiving the coupler and the locking member into the interior of the locking tube such that the attachment end of the flexible line is received into the locking tube from the first end and the locking member is received into the locking tube from the second end when the locking tube is in the connected position.

17. The method of claim 15, wherein the cap includes a socket and a pair of bayonet slots arranged opposite each other about a circumference of the cap, each bayonet slot including a catch, and the locking tube includes a pair of external projections arranged opposite each other about a circumference of the locking tube, the method further comprising:
aligning the pair of external projections with the pair of bayonet slots;
inserting the second end of the locking tube into the socket; and
twisting the locking tube to position each of the pair of external projections with the catch of each of the pair of bayonet slots to place the locking tube in the connected position.

18. The method of claim 17, wherein the cap includes a spring disposed in the socket, the method further comprising:
releasing the locking tube such that the spring biases the pair of external projections into the catch of each of the pair of bayonet slots.

19. A method of routing a fiber optic cable assembly through a pathway, the method comprising:
attaching a pulling grip assembly to the fiber optic cable assembly, wherein:
the fiber optic cable assembly comprises a fiber optic cable and a pulling loop
the fiber optic cable comprises a distribution end and an outer jacket that defines a cable interior that includes at least one strength member and a plurality of subunits each containing at least one optical fiber terminated by a fiber optic connector at the distribution end of the fiber optic cable;
the outer jacket has an end through which each of the plurality of subunits extends to the fiber optic connector;
the pulling loop is spaced from or extending beyond the end of the outer jacket, and is coupled to or defined by a portion of the at least one strength member;
the pulling grip assembly comprises a flexible line that extends a length from a gripping end to an opposite attachment end, a coupler at the attachment end of the flexible line, and a quick release assembly at the gripping end of the flexible line;
the quick release assembly is configured to receive the coupler to releasably connect the attachment end of the flexible line to the gripping end of the flexible line;
the attaching comprises routing the flexible line through the pulling loop with the attachment end and the gripping end of the flexible line being connected together at the distribution end of the fiber optic cable; and
applying a tensile load on the flexible line of the pulling grip assembly to route the fiber optic cable assembly though the pathway, the pulling grip assembly directing the tensile load to the at least one strength member of the fiber optic cable along a load path that bypasses the fiber optic connector of each of the plurality of subunits.

20. The method of claim 19, wherein:
the quick release assembly further includes:
a cap secured to the gripping end of the flexible line;
a locking tube that includes a length between a first end and an opposite second and a hollow interior, the locking tube being slidably arranged on the flexible line and slideable along the flexible line between a connected position in which the locking tube is selectively coupled to the cap and a released position in which the locking tube is decoupled from the cap; and
a locking member tethered to the gripping end of the flexible line at a location therealong between the locking tube and the cap;
the method further comprises:
decoupling the locking tube from the cap;
sliding the locking tube along the flexible line away from the cap;
disconnecting the locking member of the quick release assembly from the coupler to decouple the attachment end of the flexible line from the gripping end of the flexible line; and
pulling the gripping end of the flexible line to remove the pulling grip assembly from the fiber optic cable.
